(19) United States
(12) Patent Application Publication
(10) Pub. No.: US 2023/0192988 A1
(43) Pub. Date: Jun. 22, 2023

(54) RHEOLOGICAL ADDITIVES BASED ON DIAMIDE, FUNCTIONALIZED POLYMER AND WAX

(71) Applicant: Arkema France, Colombes (FR)

(72) Inventors: Dmitri COLESNIC, Paris (FR); Francois VETTIER, Colombes Cedex (FR); Vincent LEROY, Verneuil En Halatte (FR); Laurent LEPINAY, Verneuil En Halatte (FR)

(21) Appl. No.: 17/926,159

(22) PCT Filed: Jun. 17, 2021
(86) PCT No.: PCT/EP2021/066401

§ 371 Date: Nov. 18, 2022

(30) Foreign Application Priority Data
Jun. 18, 2020 (FR) FR2006350

(51) Int. Cl. C08K 5/20; C08K 5/06; C08K 5/00; C08L 71/00

(52) U.S. Cl. CPC C08K 5/20; C08K 5/06; C08K 5/0016; C08L 71/00

(57) ABSTRACT

The present invention relates to an additive based on diamide, functionalized polymer and wax, and also to its use as rheology agent, in particular as thixotropic agent, in a binder composition, in particular a coating composition, an adhesive, glue or mastic composition, a moulding composition, a composite material composition, a chemical sealing composition, a leaktightness agent composition, a photocrosslinkable composition for stereolithography or for 3D printing of objects.

### TECHNICAL FIELD

The present invention relates to an additive based on diamide, on functionalized polymer and on wax, and also to its use as rheology agent, in particular as thixotropic agent, in a binder composition, in particular a coating composition, an adhesive, glue or mastic composition, a moulding composition, a composite material composition, a chemical sealing composition, a leaktightness agent composition, a photocrosslinkable composition for stereolithography or for 3D printing of objects.

### PRIOR ART

Diamides based on hydroxylated fatty acid and/or on non-hydroxylated fatty acid are already known as organogelator agents, that is to say small organic molecules capable of gelling all kinds of organic solvents, even at relatively low concentrations by weight (less than 1% by weight), or as rheology additives, that is to say additives which make it possible to modify the rheology of an applicational formulation. They make it possible to obtain, for example, a thixotropic or pseudoplastic effect.

Other examples of thixotropic agents are waxes, oils and functionalized polymers.

An improvement in the rheological properties can be obtained when several different thixotropic agents are combined within an additive. However, this can cause problems of compatibility between the different thixotropic agents and/or harm the aesthetic and mechanical properties of the final formulations. It would thus be desirable to combine several thixotropic agents together in order to obtain stable additives which are easy to employ and which have improved performance qualities, without harming the properties of the binder compositions into which they are introduced.

WO 2018/146114 describes an additive based on diamide and on carboxylated polyolefin, and also its use as rheology additive for liquid systems and as anti-sag agent. The content of diamide used is from 20% to 40% by weight, with respect to the total weight of diamide and of polyolefin. This document describes that the introduction of an additive having a content of greater than 40% by weight of diamide into a composition degrades certain properties of the coating obtained, in particular a decrease in the adhesion, and also an increase in the yellowing and in the sliding resistance. Furthermore, the Applicant Company has noticed that an additive having a higher proportion of diamide with respect to the carboxylated polyolefin exhibited a heterogeneous appearance due to a problem of compatibility between the diamide and the polyolefin but also unsatisfactory rheological properties.

### DESCRIPTION OF THE INVENTION

There exists a need for a novel additive which can contain a high amount of diamide because the diamide provides an advantage in terms of thixotropic effect, with activation conditions imposed at relatively low temperature, that is to say from 40° C. to less than 80° C. The additive obtained should be stable, easy to employ and have improved performance qualities without harming the properties of the binder compositions into which it will be introduced.

After many research studies, the Applicant Company has found that the introduction of a wax into an additive based on diamide and on functionalized polymer makes it possible to meet this need.

### SUMMARY OF THE INVENTION

A first subject-matter of the invention is an additive comprising:
30% to 90% of a component A) which is at least one diamide;
5% to 40% of a component B) which is at least one functionalized polymer; and
5% to 60% of a component C) which is at least one wax;
   the % values being % values by weight, with respect to the weight of the additive.

A second subject-matter of the invention is a preactivated additive composition comprising the additive according to the invention and a plasticizer.

A third subject-matter of the invention is a binder composition comprising a binder and the additive according to the invention or the preactivated additive composition according to the invention.

Another subject-matter of the invention is the use of the additive according to the invention or of the preactivated additive composition according to the invention as a rheology agent, in particular as a thixotropic agent.

### DETAILED DESCRIPTION

### Definitions

In the present patent application, the terms “comprises a” and “comprises an” mean “comprises one or more”.

Unless otherwise mentioned, the percentages by weight in a compound or a composition are expressed with respect to the weight of the compound or of the composition.

### Component A)

The additive according to the invention comprises a component A).

The component A) is a diamide or a mixture of diamides.

Within the meaning of the present invention, a diamide is a compound having two amide (—NH—C(═O)—) functional groups.

A diamide is obtained by reaction between at least one diamine and at least one carboxylic acid. An asymmetric diamide can be obtained by reaction between a diamine and distinct carboxylic acids. A mixture of diamides can be obtained when distinct diamines and/or distinct carboxylic acids are used

According to a specific embodiment, the component A) comprises a diamide obtained with at least one diamine chosen from a C₂ to C₂₄ aliphatic diamine, a C₆ to C₁₈ cycloaliphatic diamine, a C₆ to C₂₄ aromatic diamine and their mixtures. The diamide can be obtained with a mixture of said diamines.

Within the meaning of the present invention, a diamine is a compound having two primary amine (—NH₂) functional groups.

Within the meaning of the present invention, an aliphatic diamine is an acyclic diamine A C₂ to C₂₄ aliphatic diamine is an aliphatic diamine comprising from 2 to 24 carbon atoms. An aliphatic diamine can be linear or branched, preferably linear. Examples of linear aliphatic diamines which are suitable are 1,2-ethylenediamine, 1,3-propylenediamine, 1,4-tetramethylenediamine, 1,5-pentamethylenediamine, 1,6-hexamethylenediamine, 1,8-octamethylenediamine, 1,12-dodecamethylenediamine and their mixtures; preferably 1,2-ethylenediamine, 1,5-pentamethylenediamine and 1,6-hexamethylenediamine Examples of branched aliphatic diamines which are suitable are 1,2-propylenediamine, 2,2-dimethyl-1,3-propanediamine, 2-butyl-2-ethyl-1,5-pentanediamine and their mixtures.

Within the meaning of the present invention, a cycloaliphatic diamine is a non-aromatic diamine comprising a ring, in particular a ring having six carbon atoms. A C6 to C18 cycloaliphatic diamine is a cycloaliphatic diamine comprising from 6 to 18 carbon atoms. Examples of cycloaliphatic diamines which are suitable are 1,2-, 1,3- or 1,4-diaminocyclohexane, 2-methylcyclohexane-1,3-diamine, 4-methylcyclohexane-1,3-diamine, isophoronediamine, 1,2-, 1,3- or 1,4-bis(aminomethyl)cyclohexane, diaminodecahydronaphthalene, 3,3′-dimethyl-4,4′-diaminodicyclohexylmethane, 4,4′-diaminodicyclohexylmethane, bis(aminomethyl)norbornane and their mixtures; preferably, 1,3- or 1,4-bis(aminomethyl)cyclohexane, 1,2-, 1,3- or 1,4-bis(aminomethyl)cyclohexane, isophoronediamine and 4,4′-diaminodicyclohexylmethane.

Within the meaning of the present invention, an aromatic diamine is a diamine comprising an aromatic ring. A C₆ to C₂₄ aromatic diamine is an aromatic diamine comprising from 6 to 24 carbon atoms. Examples of aromatic diamines which are suitable are meta- and para-phenylenediamine, meta- and para-xylylenediamine, meta- and para-toluylenediamine, 3,4′-diaminodiphenyl ether, 4,4′-diaminodiphenyl ether, 4,4′-diaminodiphenylmethane and their mixtures; preferably, meta- and para-xylylenediamine.

Preferably, the component A) comprises a diamide obtained with at least one diamine chosen from a C₂ to C₂₄ aliphatic diamine, in particular a linear C₂ to C₁₈ aliphatic diamine, more particularly a linear C₂ to C₁₂ aliphatic diamine, more particularly still 1,2-ethylenediamine, 1,5-pentamethylenediamine or 1,6-hexamethylenediamine

According to a specific embodiment, the component A) comprises a diamide obtained with at least one C₂ to C₃₆ carboxylic acid. The diamide can be obtained with a mixture of C₂ to C₃₆ carboxylic acids.

Within the meaning of the present invention, a C₂ to C₃₆ carboxylic acid is a compound having a carboxylic acid (—COOH) functional group and from 2 to 36 carbon atoms. The carboxylic acid can be linear or branched, preferably linear. The carboxylic acid can be saturated or unsaturated, preferably saturated. The carboxylic acid can be unsubstituted or hydroxylated. A hydroxylated carboxylic acid is a carboxylic acid substituted by one or two hydroxyl groups, preferably by one hydroxyl group.

According to a specific embodiment, the carboxylic acid can be a hydroxylated carboxylic acid, optionally as a mixture with an unsubstituted carboxylic acid.

Suitable examples of hydroxylated carboxylic acids are 12-hydroxystearic acid (12-HSA), 9-hydroxystearic acid (9-HSA), 10-hydroxystearic acid (10-HSA), 14-hydroxyeicosanoic acid (14-HEA), 2,2-bis(hydroxymethyl)propionic acid, 2,2-bis(hydroxymethyl)butyric acid, hydroxyacetic acid (or glycolic acid), 2-hydroxypropionic acid (lactic acid), 2-hydroxy-3-(3-pyridyl)propionic acid, 3-hydroxybutyric acid, 2-hydroxybutyric acid, 2-methyl-2-hydroxybutyric acid, 2-ethyl-2-hydroxybutyric acid, hydroxypentanoic acid, hydroxyhexanoic acid, hydroxyheptanoic acid, hydroxyoctanoic acid, hydroxynonanoic acid, hydroxydecanoic acid and their mixtures; preferably, 12-hydroxystearic acid or a binary or ternary mixture of 12-hydroxystearic acid with the other abovementioned hydroxylated acids.

Suitable examples of unsubstituted carboxylic acids are acetic acid, propionic acid, butyric acid, pentanoic acid, hexanoic acid, heptanoic acid, octanoic acid, nonanoic acid, decanoic acid, lauric acid, myristic acid, palmitic acid, stearic acid, eicosanoic acid, palmitoleic acid, oleic acid, 11-eicosenoic acid, erucic acid, nervonic acid, linoleic acid, α-linolenic acid, γ-linolenic acid, dihomo-γ-linolenic acid, arachidonic acid, eicosapentaenoic acid, docosahexaenoic acid and their mixtures; preferably decanoic acid.

Preferably, the component A) comprises a diamide obtained with at least one carboxylic acid chosen from a C₂ to C₂₂ carboxylic acid, in particular a hydroxylated C₂ to C₂₂ carboxylic acid and optionally an unsubstituted C₂ to C₂₂ carboxylic acid, more particularly a hydroxylated C₁₂ to C₂₀ carboxylic acid and optionally an unsubstituted C₂ to C₁₄ carboxylic acid.

According to a preferred embodiment, the component A) comprises a diamide having a melting point of less than 250° C., of less than 225° C., of less than 210° C. or of less than 200° C. According to a particularly preferred embodiment, the component A) comprises a diamide obtained by reaction between 1,2-ethylenediamine, 1,5-pentamethylenediamine or 1,6-hexamethylenediamine and 12-hydroxystearic acid and optionally decanoic acid.

The additive according to the invention comprises from 30% to 90% by weight of component A), with respect to the weight of the additive. The additive can in particular comprise from 35% to 90%, in particular from 40% to 90%, more particularly from 40% to 85%, by weight of component A), with respect to the weight of the additive.

According to a specific embodiment, the additive can comprise from 30% to 60%, in particular from 35% to 55%, more particularly from 40% to 50%, by weight of component A), with respect to the weight of the additive.

According to another embodiment, the additive can comprise from 70% to 90%, in particular from 75% to 90%, more particularly from 80% to 90%, by weight of component A), with respect to the weight of the additive.

### Component B)

The additive according to the invention comprises a component B). The component B) is distinct from the components A) and C).

The component B) is a functionalized polymer or a mixture of functionalized polymers.

Within the meaning of the present invention, a functionalized polymer is a polymer comprising a backbone carrying functional groups. Functional groups are groups capable of reacting with other compounds during a reaction or of facilitating the compatibilization of the polymer in the additive. The backbone of the polymer is the main chain comprising units resulting from the polymerization of monomers, in particular ethylenically unsaturated monomers. A functionalized polymer can be obtained by functionalization of an existing polymer, in particular by an oxidation reaction or grafting reaction. Alternatively, a functionalized polymer can be obtained by introducing monomers carrying functional groups during the polymerization reaction.

The functionalized polymer can in particular have a weight-average molecular weight of 600 to 20000 g/mol, especially of 1000 to 5000 g/mol.

The functionalized polymer can in particular be a wax. Within the meaning of the present invention, a wax is a compound which is solid at 20° C. A wax can begin to melt at temperatures of greater than 45° C. without decomposing. A wax can exhibit a low viscosity (of less than 50 mPa·s) above its melting point. A wax can be insoluble in water. A wax can in particular be malleable at 20° C. A wax can in particular exhibit a softening point of greater than 70° C., especially of 70° C. to 120° C.

According to a specific embodiment, the component B) comprises a polymer functionalized by polar groups, in particular polar groups chosen from carboxylic acid, anhydride, ether, aldehyde, alcohol, amine and their mixtures. More particularly, the functionalized polymer contains at least carboxylic acid groups.

The component B) can in particular comprise a functionalized polymer having an acid number of 3 to 50, or 5 to 40, or 8 to 35, or 10 to 25 mg KOH/g.

The functionalized polymer can be chosen from a polyolefin, a polyester, a polyether, a (meth)acrylic polymer, a polyurethane, a polyamide, a styrene/maleic copolymer and their mixtures. The functionalized polymer can in particular comprise a backbone resulting from the polymerization of one or more monomers chosen from polyol, poly(carboxylic acid), polyester, anhydride, polyisocyanate, polyamine, diepoxide, an ethylenically unsaturated monomer and their mixtures. The ethylenically unsaturated monomers are monomers having a polymerizable carbon-carbon double bond. A polymerizable carbon-carbon double bond is generally comprised in a group chosen from acrylate (including cyanoacrylate), methacrylate, acrylamide, methacrylamide, styrene, maleate, fumarate, itaconate, allyl, propenyl, vinyl and corresponding combinations. The carbon-carbon double bonds of a phenyl ring are not regarded as polymerizable carbon-carbon double bonds.

According to a specific embodiment, the component B) comprises a functionalized polyolefin, in particular an oxidized polyolefin, more particularly an oxidized polyethylene.

Within the meaning of the present invention, a polyolefin is a polymer comprising units resulting from the polymerization of olefins. An olefin is an alkene, in particular an alkene having from 2 to 8, in particular from 2 to 6, more particularly from 2 to 4, carbon atoms. Preferably, the olefins used in order to obtain polyolefins are a-olefins, that is to say olefins having a terminal carbon-carbon double bond. Examples of olefins which are suitable are ethylene, propylene, 1-butene, isobutene and their mixtures, preferably ethylene and propylene.

A polyolefin can be a homopolymer of olefins of a single type (ethylene homopolymer, for example) or a copolymer of at least two olefins (for example, polymers of mixtures of ethylene, propylene, 1-butene and/or isobutene). In addition, a polyolefin can also comprise one or more units resulting from the polymerization of ethylenically unsaturated monomers other than olefins, more particularly ethylenically unsaturated monomers having a carboxylic acid or anhydride group. These ethylenically unsaturated monomers can be copolymerized with the olefins or added subsequently, for example by grafting. When ethylenically unsaturated monomers having carboxyl or anhydride groups are used, the resulting polyolefin is functionalized by carboxylic acid or anhydride groups.

Within the meaning of the present invention, an oxidized polyolefin is a polyolefin containing at least carboxylic acid groups. An oxidized polyolefin can additionally comprise one or more groups chosen from aldehyde, ketone, ether, alcohol and their mixtures. An oxidized polyolefin can in particular be obtained according to one of the following methods:

1) by oxidation, in particular oxidation in the molten state, of a non-polar polyolefin, especially of a non-polar polyethylene;

2) by oxidative degradation of polyolefin plastics, especially of polyethylene plastics;

3) by polymerization of olefins, in particular of ethylene and/or of propylene, with ethylenically unsaturated monomers having a carboxylic acid or anhydride group, in particular (meth)acrylic acid;

4) by radical grafting of ethylenically unsaturated monomers having a carboxylic acid or anhydride group, in particular maleic anhydride, to a non-polar polyolefin, in particular a non-polar polythene and/or polypropylene.

According to one embodiment, the oxidized polyolefin is a homopolymer or a copolymer of at least one olefin, in particular of an α-olefin, more particularly ethylene and/or propylene.

The oxidized polyolefin can in particular be chosen from an oxidized polyethylene, an oxidized polypropylene, an oxidized poly(ethylene-co-propylene), an oxidized ethylene/α-olefin copolymer, a copolymer of ethylene and of (meth)acrylic acid, a polymer of ethylene and/or of propylene grafted with an ethylenically unsaturated monomer carrying a carboxylic acid or anhydride group, for example with (meth)acrylic acid or maleic anhydride.

Products of this type are available, for example, under the references AC 680, AC 629 or AC 673P sold by Honeywell; Viscowax® 252 and Viscowax® 253 sold by Innospec Leuna; Deurex E040 sold by Deurex; Licowax® PED 521, Licowax® PED 522 or Licolub® H 12 sold by Clariant; or Epolene® E 14 sold by Westlake.

The additive according to the invention comprises from 5% to 40% by weight of component B), with respect to the weight of the additive. The additive can in particular comprise from 5% to 35%, in particular from 10% to 35%, more particularly from 10% to 30%, by weight of component B), with respect to the weight of the additive.

According to a specific embodiment, the additive can comprise from 15% to 40%, in particular from 20% to 40%, more particularly from 25% to 35%, by weight of component B), with respect to the weight of the additive.

According to another embodiment, the additive can comprise from 5% to 25%, in particular from 5% to 20%, more particularly from 5% to 15%, by weight of component B), with respect to the weight of the additive.

### Component C)

The additive according to the invention comprises a component C). The component C) is distinct from the components A) and B).

The component C) is a wax or a mixture of waxes.

The component C) advantageously makes it possible to compatibilize the components A) and B) in order for the additive to be able to form a homogeneous mixture which can be micronized.

The component C) can comprise a wax having a softening point of greater than 70° C., in particular of 70° C. to 120° C.

The component C) can comprise a wax having an acid number of less than 10 mg KOH/g, in particular of less than 5 mg KOH/g, more particularly of less than 3 mg KOH/g, more particularly still of less than 2.5 mg KOH/g.

According to a specific embodiment, the component C) comprises a wax chosen from a mineral wax, a natural wax, a synthetic wax and their mixtures.

A mineral wax is obtained from crude oil, coal or lignite. The mineral wax can in particular be chosen from a paraffin wax, a microcrystalline wax, a ceresin, a montan wax and their mixtures. The cut obtained by distillation of crude oil between 400° C. and 500° C. contains paraffin waxes and also microcrystalline waxes. They are saturated hydrocarbons having 18 to 60 carbon atoms. Microcrystalline waxes have long and branched chains which confer a microcrystalline structure on them. They are soft, white and non-translucent and have a melting point of greater than 70° C. Paraffin waxes have slightly shorter and linear chains which confer a macrocrystalline structure on them. They are white, translucent and stiff solids which easily break and have a melting point between 50° C. and 70° C. A ceresin is a mixture of hydrocarbons obtained by purification of ozokerite. Montan waxes (esters of montanic acid and of an alcohol chosen from ethylene glycol, butane-1,3-diol or glycerol) are obtained by extraction of lignites (coal rich in fossilized plants).

A natural wax can in particular be chosen from a ceride, a diol or triol completely or partially esterified with fatty acids, a vegetable or animal wax, and their mixtures. Cerides are esters of fatty acids and of fatty alcohols. The fatty acids can be saturated or unsaturated, unsubstituted or hydroxylated, linear-chain carboxylic acids having from 12 to 36 carbon atoms, preferably as even number. The fatty alcohols can be monoalcohols having from 12 to 36 carbon atoms. The diols and triols completely or partially esterified with fatty acids (preferably hydroxylated fatty acids) can in particular be chosen from ethylene glycol, propane-1,2-diol, glycerol, a diol having from 12 to 36 carbon atoms and their mixtures. Plant or animal waxes comprise the group of the compounds extracted from plants or animals during the production of wax, of oil or of butter, and also the transformed products, in particular transformed by a hydrogenation or metathesis reaction, obtained from these compounds. Oils and butters which are solid at 20° C., in particular partially or completely hydrogenated vegetable oils, are thus regarded as vegetable or animal waxes within the meaning of the present invention. The oils and butters contain mainly diesters and triesters of fatty acids (preferably hydroxylated fatty acids) and of glycerol. Examples of cerides are cetyl palmitate, dodecyl laurate, octadecyl stearate, tetradecyl myristate, myricyl palmitate and myricyl cerotate. Examples of vegetable or animal waxes are beeswax, candelilla wax, carnauba wax, rice bran wax, Japan wax, soy wax, rapeseed wax, palm wax, spermaceti, shea butter, cocoa butter, tristearin, hydrogenated castor oil, hydrogenated coconut oil, hydrogenated cottonseed oil, hydrogenated rapeseed oil, hydrogenated soybean oil, hydrogenated palm oil and their mixtures.

Synthetic waxes are mainly hydrocarbons (alkanes and alkenes) and polyoxyalkylenes synthesized by man The synthetic wax can in particular be a Fischer-Tropsch wax, a polyethylene and/or polypropylene wax, a poly(ethylene oxide) and/or poly(propylene oxide) wax and their mixtures. The Fischer-Tropsch waxes contain predominantly alkanes and are obtained from a mixture of CO and H₂. This wax is hard and has a macrocrystalline structure comparable to that of natural paraffin waxes. The polyethylene and/or polypropylene waxes can be obtained by cracking of polyethylene and/or of polypropylene. A polymer having shorter chains of formula H—(CH₂—CHR)ₙ—H, each R being independently H or methyl et n varying from 50 to 100, is obtained. The poly(ethylene oxide) and/or poly(propylene oxide) waxes correspond to a polymer of unit H—(O—CHR—CH₂)ₙ—OH, each R being independently H or methyl and n varying from 20 to 100.

According to a preferred embodiment, the component C) comprises a hydroxylated wax, in particular a hydroxylated wax having an OH number of greater than 25 mg KOH/g, of greater than 50 mg KOH/g, of greater than 75 mg KOH/g, of greater than 100 mg KOH/g, of greater than 125 mg KOH/g, of greater than 150 mg KOH/g or of greater than 155 mg KOH/g.

In particular, the component C) can comprise a natural wax chosen from a diol or triol completely or partially esterified with a fatty acid, an ester of fatty acid and of fatty alcohol, in which the fatty acid is a saturated or unsaturated, linear-chain, hydroxylated carboxylic acid having from 12 to 36 carbon atoms, preferably as even number.

According to a particularly preferred embodiment, the component C) comprises hydrogenated castor oil.

The additive according to the invention comprises from 5% to 60% by weight of component C), with respect to the weight of the additive. The additive can in particular comprise from 5% to 55%, especially from 10% to 55%, more particularly from 10% to 50%, by weight of component C), with respect to the weight of the additive.

According to a specific embodiment, the additive can comprise from 10% to 40%, in particular from 15% to 35%, more particularly from 20% to 30%, by weight of component C), with respect to the weight of the additive.

According to another embodiment, the additive can comprise from 5% to 25%, in particular from 5% to 20%, more particularly from 10% to 20%, by weight of component C), with respect to the weight of the additive.

### Additive

The additive according to the invention comprises:
from 30% to 90%, in particular from 35% to 90%, more particularly from 40% to 90%, more particularly still from 40% to 85%, of component A);
from 5% to 40%, in particular from 5% to 35%, more particularly from 10% to 35%, more particularly still from 10% to 30%, of component B); and
from 5% to 60%, in particular from 5% to 55%, more particularly from 10% to 55%, more particularly still from 10% to 50%, of component C);
   the % values being % values by weight, with respect to the weight of the additive.

According to a specific embodiment, the additive comprises:
from 30% to 60%, in particular from 35% to 55%, more particularly from 40% to 50%, of component A);
from 15% to 40%, in particular from 20% to 40%, more particularly from 25% to 35%, of component B); and
from 10% to 40%, in particular from 15% to 35%, more particularly from 20% to 30%, of component C);
   the % values being % values by weight, with respect to the weight of the additive.

According to another specific embodiment, the additive comprises:
from 70% to 90%, in particular from 75% to 90%, more particularly from 80% to 90%, of component A);
from 5% to 25%, in particular from 5% to 20%, more particularly from 5% to 15%, of component B); and
from 5% to 25%, in particular from 5% to 20%, more particularly from 10% to 20%, of component C);
   the % values being % values by weight, with respect to the weight of the additive.

The additive can additionally comprise from 0% to 10%, in particular from 0% to 5%, more particularly from 0% to 2%, by weight, with respect to the weight of the additive, of a component D) which is at least one compound other than the components A), B) and C).

The component D) can in particular comprise a by-product related to the preparation of the components A), B) and C). Examples of such by-products are a catalyst, in particular an inorganic salt, a metal oxide or a semimetal oxide; a diamine; a C₂ to C₃₆ carboxylic acid; a monoamide resulting from the reaction between a diamine and one equivalent of C₂ to C₃₆ carboxylic acid.

The additive can be composed essentially of or can consist of the components A), B), C) and D). Thus, the total weight of the components A), B), C) and D) can represent 100% of the weight of the additive.

According to a specific embodiment, the ratio by weight of the component A) to the component B) ranges from 0.8 to 10, in particular from 1 to 9, more particularly from 1.5 to 8.5.

The additive according to the invention can in particular be in the solid form, especially in the form of solid particles, more particularly in the form of solid particles having a volume-average size of less than 50 μm or of less than 25 μm.

The additive can be obtained according to a process comprising the following stages:

a) mixing the components A), B), C) and optionally D) at high temperature (140 to 220° C.) in order to form a homogeneous mixture;

b) cooling the mixture obtained in stage a) to ambient temperature (20-25° C.) in order to obtain a solid;

c) micronizing the solid obtained in stage b) in order to obtain solid particles having a volume-average size of less than 50 μm.

Alternatively, the additive according to the invention can be in the form of a preactivated paste. Thus, the additive according to the invention can be mixed with a plasticizer in order to form a preactivated additive composition as described below.

### Preactivated Additive Composition

The preactivated additive composition according to the invention comprises the additive as described above and a plasticizer.

Within the meaning of the present invention, a plasticizer is a compound which facilitates the use of the additive.

Preferably, said plasticizer is polar organic plasticizer comprising at least one polar group, preferably an ether group and/or an ester group and/or an epoxy group.

Mention may be made, among the plasticizers having an ester group, of those comprising at least one C₆ to C₁₀ aromatic acid ester group, in particular the plasticizers selected from mono- and/or dialkyl phthalates, and more preferentially still from dialkyl phthalates, with said alkyls being able to be identical or different, and chosen from C₇ to C₁₈ and preferably C₁₀ to C₁₂ alkyls. Mention may also be made of alkylsulfonates and preferentially of the ester of alkylsulfonic acid with phenol, and of dibenzoates.

Mention may be made, among the plasticizers having an ether group, of the homopolymer polyethers of propylene oxide (polypropylene glycols) with a weight-average molecular weight Mw ranging from 1000 to 3000, and more particularly of polypropylene glycol (PPG) with an Mw equal to 2000, and/or their derivatives, chosen from the monoesters, preferably C₂ to C₄ monoesters, or the C₁ to C₄ monoethers, such as the monomethoxylated or monoethoxylated derivatives.

According to a specific embodiment, the plasticizer comprises a mono- and/or a dialkyl phthalate.

The preactivated additive composition is advantageously ready for use by the final user (formulator of mastics, of glues, of adhesives, or of coatings, such as paints, or varnishes, or gel coats, or inks, or of moulding composition) by simple mixing in the final applicational formulation, without any specific in situ activation being needed in this formulation (specific conditions of temperature, of shearing and of duration to be observed).

### Binder Composition

The additive according to the invention is advantageously introduced into a binder composition in order to modify its rheology, in particular in order to confer a thixotropic or pseudoplastic effect on it.

The binder composition according to the invention comprises a binder and the additive as described above or the preactivated additive composition as described above.

According to a specific embodiment, the binder composition is a coating composition, in particular a varnish, rendering, surface gel, paint or ink composition, an adhesive, glue or mastic composition, a moulding composition, a composite material composition, a chemical sealing composition, a leaktightness agent composition, a photocrosslinkable composition for stereolithography or for 3D printing of objects, in particular by inkjet printing.

The binder composition can in particular comprise from 0.5% to 15%, especially from 1% to 10%, more particularly from 2% to 7%, by weight of additive, with respect to the total weight of said composition.

According to a specific embodiment, the binder composition according to the invention is crosslinkable, either thermally or by radiation under radiation, such as UV (in the presence of at least one photoinitiator) and/or EB (electron beam, without initiator), including self-crosslinkable at ambient temperature, or it is non-crosslinkable. The binder composition can be crosslinkable one-component (a single reactive component) or crosslinkable two-component (binder based on two components which react together by mixing during use).

The binder can be selected from at least one epoxy-amine reactive system (crosslinkable two-component), an unsaturated polyester, a vinyl ester, an epoxidized resin, a reactive silicone resin, an alkyd grafted by a polyester or a polyamide or diurea/diurethane-modified, or an ungrafted alkyd, a polyurethane or a silicone resin, a crosslinkable two-component polyurethane, a polysiloxane, a polysulfide polymer, a reactive acrylic polymer, a (meth)acrylate multifunctional oligomer or acrylated acrylic oligomer or allylic multifunctional oligomer, an elastomer of SBR, polychloroprene or butyl rubber type, or a silanated prepolymer, preferably a silanated polyether or a silanated polyurethane, or a silanated polyether-urethane with an —OH or —CO₂H functional group.

In a more specific case, the binder can be selected from the following crosslinkable two-component reactive systems: epoxy-amine or epoxy-polyamide systems comprising at least one epoxy resin comprising at least two epoxy groups and at least one amino or polyamide compound comprising at least two amine groups, polyurethane systems comprising at least one polyisocyanate and at least one polyol, polyol-melamine systems, and polyester systems based on at least one epoxy or on a polyol reactive with at least one acid or one corresponding anhydride.

According to other specific cases, the binder can be a crosslinkable two-component polyurethane system or a crosslinkable two-component polyester system starting from an epoxy-carboxylic acid or anhydride reaction system, or from a polyol-carboxylic acid or anhydride system, or a polyol-melamine reaction system in which the polyol is a hydroxylated acrylic resin, or a polyester or a polyether polyol.

The binder composition according to the invention can comprise other components, such as, for example, fillers, plasticizers, wetting agents or also pigments.

According to an alternative form, the binder composition according to the invention is a mastic, glue, adhesive or leaktightness agent composition, which is self-crosslinkable, and based on polyether-silane or polyurethane-silane binder.

More particularly, the binder composition according to the invention can be a one-component mastic composition based on silylated (or silanated, this term being regarded as synonymous with silylated for the present invention), and preferably on silylated polyether or on silylated polyurethane (silylated polyether-urethane), such as Kaneka MS Polymer™ and Kaneka Silyl™.

Other components can be added or substituted in the one-component mastic compositions based on silylated prepolymer, such as other types of binders, coloured pigments, various plasticizers, fillers of precipitated or ground calcium carbonate type, glyceride derivatives, silicas, such as a fumed silicas, other additives, such as UVAs (UV antioxidants), for example 2,4-di(tert-butyl)-6-(5-chlorobenzotriazol-2-yl)phenol (Tinuvin® 327 from BASF), light stabilizers based on sterically hindered amines, such as HALS (Hindered Amine Light Stabilizers), for example bis(2,2,6,6-tetramethyl-4-piperidyl) sebacate (Tinuvin® 770 from BASF), waxes, and other types of catalysts, such as tin salts.

### Use

The additive or the preactivated additive composition according to the invention is used as a rheology agent, in particular as a thixotropic agent.

Thus, the incorporation of the additive or of the preactivated additive composition in a binder composition makes it possible to modify its rheology, in particular to confer a thixotropic effect on it. Thus, the binder composition can be in the form of a gel when it is at rest (no mechanical stress). This increase in viscosity in comparison with a binder composition not containing thixotropic additive is advantageous since this makes it possible to prevent the spreading of the composition and run-offs once the composition has been applied to a substrate. When the binder composition is subjected to shearing, its viscosity decreases, which makes it possible to facilitate its application to a substrate.

By way of illustration of the invention, the following examples demonstrate, without any limitation, the performance qualities of the additive according to the present invention.

### EXAMPLES

### Starting Materials

In the examples, the following starting materials were used:

TABLE 1

| Chemical name | Function | Commercial reference | Supplier |
|---|---|---|---|
| 1,6-Hexamethylenediamine | Diamine of component A) | HMD | Ascend |
| (HMDA) | | | |
| 12-Hydroxystearic acid (12- | Carboxylic acid of | 12-HSA | Jayant Agro |
| HSA) | component A) | | |
| Polyethylene oxide | Component B) | Viscowax ® 253 | Innospec |
| | | | Leuna |
| Hydrogenated castor oil | Component C) | HCO | Gokul |
| C₁₃-C₁₅ Alkane | Plasticizer | Hydroseal G3H | Total |
| Silyl-terminated polyether | Binder | MS Polymer ® S203H | Kaneka |
| Alkylsulfonic phenyl ester | Plasticizer | Mesamoll ® | Lanxess |

### Measurement Methods

In the present patent application, the following measurement methods were used:

Weight-Average Molecular Weight:

The weight-average molecular weight was measured according to OECD (1996), Test No. 118: Determination of the Number-Average Molecular Weight and the Molecular Weight Distribution of Polymers using Gel Permeation Chromatography, OECD Guidelines for the Testing of Chemicals, Section 1, Éditions OCDE [OECD Publications], Paris.

Acid Number:

The acid number was measured according to Standard DIN EN ISO 2114-November 2000, using a 50:50 v/v xylene/ethanol mixture as titration solvent. The sample was weighed into a 250 ml Erlenmeyer flask and dissolved in 100 ml of the hot xylene/ethanol mixture (approximately 90° C.) on a magnetic stirrer. The sample was subsequently placed on the magnetic stirrer of the titrimeter, the electrode was thoroughly immersed and the mixture was titrated with a 0.1M ethanolic KOH solution.

Amine Number:

The amine number was determined in accordance with Standard DIN 53176—November 2002, using a 50:50 v/v xylene/ethanol mixture as titration solvent. The sample was weighed into a 250 ml Erlenmeyer flask and dissolved in 100 ml of the hot xylene/ethanol mixture (approximately 90° C.) on a magnetic stirrer. The sample was subsequently placed on the magnetic stirrer of the titrimeter, the electrode was thoroughly immersed and the mixture was titrated with a 0.1M isopropanolic HCl solution.

Softening Point:

The softening point was measured according to the method NF ISO 2176-June 2006.

Size of the Particles:

The size of the particles was measured by laser particle size analysis on the Mastersizer 3000 (Malvern) device. The powder was dispersed in air and passed in front of a laser cell. The light intensity was measured and processed iteratively in order to obtain the correct particle size distribution. The size of the particles was expressed by volume. The Dv50 (also denoted D0.5 or ×50) corresponds to the median diameter (50% of the particles are less than the corresponding diameter).

Yield Stress:

The yield stress was measured using a Kinexus Pro (Malvern) rheometer. It corresponds to the stress located at the intersection of the storage modulus (G′) and the loss modulus (G″) and is expressed in Pa. It describes the stress from which the liquid behaviour of the sample supplants its solid nature and its structure flows. The curves of the storage modulus (G′) and of the loss modulus (G″) were determined according to the method described below.

Storage Modulus (G′):

The storage modulus was measured using a Kinexus Pro (Malvern) controlled-stress rheometer. This modulus quantifies the solid nature and thus the level of structure of the material and is expressed in Pa. In order to determine it, a stress sweep from 0.1 to 10 000 Pa was carried out at a frequency of 1 Hz. The gap was 1 mm for the plate/plate geometry used.

### Example 1: Preparation of a Diamide (Component A)

77.83 g of HMDA (0.67 mol, 1 eq) and 422.17 g of 12-HSA (1.34 mol, 2 eq) were added to a 1 litre round-bottomed flask equipped with a thermometer, a Dean and Stark apparatus, a condenser and a stirrer. The mixture was heated to 180° C. under an inert atmosphere. The water removed accumulated in the Dean and Stark apparatus from 150° C. The reaction was monitored by the acid number and the amine number. When the acid number and the amine number were less than 5, the reaction was halted. The reaction mixture was cooled to 140° C. and discharged into a silicone mould. Once cooled to ambient temperature (20-25° C.), the product was converted into flakes.

### Example 2: Preparation of an Additive According to the Invention

72 g of diamide prepared according to Example 1, 18 g of polyethylene oxide wax and 10 g of hydrogenated castor oil were mixed at 140° C. under an inert atmosphere for 30 minutes in a 1 l round-bottomed flask equipped with a thermometer, a Dean and Stark apparatus, a condenser and a stirrer. The reaction mixture was subsequently discharged into a silicone mould. Once cooled to ambient temperature (20-25° C.), the product was converted into flakes. The additive was subsequently micronized by an air jet in order to obtain a fine (Dv50 of less than 50 μm) and controlled particle size distribution.

### Example 3: Preparation of an Additive According to the Invention

40 g of diamide prepared according to Example 1, 10 g of polyethylene oxide wax and 50 g of hydrogenated castor oil were mixed at 140° C. under an inert atmosphere for 30 minutes in a 1 l round-bottomed flask equipped with a thermometer, a Dean and Stark apparatus, a condenser and a stirrer. The reaction mixture was subsequently discharged into a silicone mould. Once cooled to ambient temperature (20-25° C.), the product was converted into flakes. The additive was subsequently micronized by an air jet in order to obtain a fine (Dv50 of less than 50 μm) and controlled particle size distribution.

### Example 4: Preparation of a Comparative Additive

80 g of diamide prepared according to Example 1 and 20 g of polyethylene oxide wax were mixed at 140° C. under an inert atmosphere for 30 minutes in a 1 l round-bottomed flask equipped with a thermometer, a Dean and Stark apparatus, a condenser and a stirrer. The reaction mixture was subsequently discharged into a silicone mould. Once cooled to ambient temperature, the product was converted into flakes. The additive was subsequently micronized by an air jet in order to obtain a fine (Dv50 of less than 50 μm) and controlled particle size distribution.

### Example 5: Evaluation of the Performance Qualities of the Additives in Mastics

1) Preparation of the Mastics

The additives prepared were evaluated in a mastic formulation. The mastic formulation was prepared with the ingredients presented in Table 2 below (the % values by weight are expressed with respect to the weight of the mastic formulation):

TABLE 2

| Component | Function | % by weight |
|---|---|---|
| Mesamoll plasticizer | Plasticizer | 25 |
| MS-Polymer ® S 203 H | Binder | 64 |
| Hydroseal G3H | Plasticizer | 6 |
| Additive of Examples 2 to 4 | Rheology additive | 5 |

The formulations were prepared using a high-speed disperser (HSD). The resin and the plasticizer were added and homogenized in a first stage and in the proportions shown (Table 2). The additive was weighed out and subsequently added during the second stage. Thus, the reaction mixture was brought to 50° C. for 30 minutes under stirring of 3000 revolutions per minute. At the end of this phase, the mixture was discharged and the rheological performance qualities of these formulations were evaluated.

2) Characterization of the Mastics

The yield stress and the storage modulus (G′) of the mastics prepared with the additives of Examples 2 to 4 are presented in Table 3 below. A control mastic (without additive) was also tested.

TABLE 3

| Additive used | Gel appearance | Yield stress (Pa) | G′ (Pa) |
|---|---|---|---|
| Control (without additive) | No gel | Not determinable | 1.2 |
| Example 2 (invention) | Gel | 25 | 492 |
| Example 3 (invention) | Strong gel | 183 | 3980 |
| Example 4 (comparative) | No gel | Not determinable | 7 |

The mastics containing the rheology additives according to the invention show superior rheological performance qualities compared with the mastic containing a mixture of diamide and of polyethylene oxide without hydrogenated castor oil.

1. An additive comprising:
30% to 90% of a component A) which is at least one diamide;
5% to 40% of a component B) which is at least one functionalized polymer; and
5% to 60% of a component C) which is at least one wax;
the % values being % values by weight, with respect to the weight of the additive.

2. The additive according to claim 1, wherein component A) comprises a diamide obtained by reaction between at least one diamine and at least one carboxylic acid,
the diamine being chosen from a C2 to C24 aliphatic diamine, a C6 to C18 cycloaliphatic diamine, a C6 to C24 aromatic diamine and their mixtures; and
the carboxylic acid being a saturated or unsaturated, linear or branched, unsubstituted or hydroxylated, C2 to C36 carboxylic acid.

3. The additive according to claim 2, wherein component A) comprises a diamide obtained with at least one diamine chosen from a C2 to C24 aliphatic diamine.

4. The additive according to claim 2 wherein component A) comprises a diamide obtained with at least one carboxylic acid chosen from a C2 to C22 carboxylic acid, and optionally an unsubstituted C2 to C22 carboxylic acid.

5. The additive according to claim 1 wherein component A) comprises a diamide obtained by reaction between 1,2-ethylenediamine, 1,5-pentamethylenediamine or 1,6-hexamethylenediamine and 12-hydroxystearic acid and optionally decanoic acid.

6. The additive according to claim 1 wherein the additive comprises from 35% to 90% by weight of component A), with respect to the weight of the additive.

7. The additive according to claim 1 wherein component B) comprises a polymer functionalized by polar groups.

8. The additive according to claim 1 wherein component B) comprises a functionalized polymer having an acid number of 3 to 50, or 5 to 40, or 8 to 35, or 10 to 25 mg KOH/g.

9. The additive according to claim 1 wherein component B) comprises a functionalized polyolefin.

10. The additive according to claim 1 wherein the additive comprises from 5% to 35% by weight of component B), with respect to the weight of the additive.

11. The additive according to claim 1 wherein component C) comprises a wax exhibiting a softening point of greater than 70° C.

12. The additive according to claim 1 wherein component C) comprises a wax chosen from a mineral wax, a natural wax, a synthetic wax and their mixtures; a paraffin wax, a microcrystalline wax, a ceresin, a montan wax, a ceride, a diol or triol completely or partially esterified with fatty acids, a vegetable or animal wax, a Fischer-Tropsch wax, a polyethylene and/or polypropylene wax, a poly(ethylene oxide) and/or poly(propylene oxide) wax and their mixtures; and hydrogenated castor oil.

13. The additive according to claim 1 wherein component C) comprises a hydroxylated wax.

14. The additive according to claim 1 wherein the additive comprises from 5% to 55% by weight of component C), with respect to the weight of the additive.

15. The additive according to claim 1 wherein a ratio by weight of the component A) to the component B) ranges from 0.8 to 10.

16. The additive according to claim 1 wherein the additive is in solid form.

17. A preactivated additive composition comprising the additive according to claim 1 and a plasticizer.

18. A binder composition comprising a binder and the additive according to claim 1.

19. The binder composition according to claim 18, which is a coating composition, a varnish, rendering, surface gel, paint or ink composition, an adhesive, glue or mastic composition, a moulding composition, a composite material composition, a chemical sealing composition, a leaktightness agent composition, a photocrosslinkable composition for stereolithography or for 3D printing of objects.

20. (canceled)
